(19) United States
(12) Patent Application Publication
(10) Pub. No.: US 2026/0238100 A1
(43) Pub. Date: Aug. 13, 2026

(54) COAXIAL MULTI-DOF SINGLE MOTOR WITH ITS TOPOLOGY AND STRUCTURE DESIGN METHOD

(71) Applicants: ZHEJIANG UNIVERSITY, Zhejiang (CN); ZHEJIANG UNIVERSITY ADVANCED ELECTRICAL EQUIPMENT INNOVATION CENTER, Zhejiang (CN)

(72) Inventors: Tingna SHI, Zhejiang (CN); Yiyang XU, Zhejiang (CN); Dong YAN, Zhejiang (CN); Yanfei CAO, Zhejiang (CN); Changliang XIA, Zhejiang (CN)

(73) Assignees: ZHEJIANG UNIVERSITY, Zhejiang (CN); ZHEJIANG UNIVERSITY ADVANCED ELECTRICAL EQUIPMENT INNOVATION CENTER, Zhejiang (CN)

(21) Appl. No.: 19/645,284

(22) Filed: Apr. 12, 2026

Related U.S. Application Data
(63) Continuation of application No. PCT/CN2025/113141, filed on Aug. 7, 2025.

(30) Foreign Application Priority Data
Aug. 20, 2024 (CN) 202411143429.6

(51) Int. Cl. H02K 16/02

(52) U.S. Cl. CPC H02K 16/02

(57) ABSTRACT

A coaxial multi-degree-of-freedom (multi-DOF) single motor with its topology and structure design method is disclosed in the present invention. A single stator with one set of concentrated windings is adopted, and the winding configuration is designed based on the required control DOFs through a variable slot pitch angle method. The rotor part adopts the hybrid-embedded structure and the coaxial-nested shafts, such that the multi-rotor operation within a single motor is realized. The parameters of the rotor part are configured according to the parameters of the stator part and the winding configuration. In this design, rotating magnetic fields with different pole-pair numbers are generated by a common set of stator windings. Decoupled control and multi-DOF operation of multiple rotors are achieved in a single machine. Furthermore, the split-tooth structure is added to introduce the flux modulation effect in the air-gap magnetic field.

### CROSS REFERENCE TO RELATED APPLICATIONS

This application is a continuation of international application of PCT application serial no. PCT/CN2025/113141, filed on Aug. 7, 2025, which claims the priority benefit of China application serial no. 202411143429.6, filed on Aug. 20, 2024. The entirety of the above-mentioned patent application is hereby incorporated by reference herein and made a part of this specification.

### TECHNICAL FIELD

The present invention relates to the field of permanent magnet motor design, and more particularly to a design method for the topology and structure of a multi-axis motor.

### BACKGROUND

In recent years, advanced equipment combined with artificial intelligence, such as industrial robotic arms, bionic robots, precision CNC machine tools, and intelligent medical devices, has developed rapidly and has become a primary research and development point in high-tech fields. The driving force for the automated operation of these highly intelligent devices mostly originates from electric motors, and the realization of complex spatial movements or precise point positioning requires the coordinated operation of motors in multiple DOFs.

Conventional multi-axis systems, which consist of multiple single-DOF motors and complex transmission mechanisms, are prone to reduced control accuracy and weakened operational stability of the entire system due to error accumulation and imprecise system models. To address this problem, a multi-DOF single motor with multiple operational DOFs can be adopted to replace the conventional multiple single-DOF motors in the multi-axis system. Then, the mechanical complexity of the system is effectively reduced, the compactness of the actuator is improved, and the dynamic stability of the system is enhanced. Therefore, the multi-DOF single motor is potential to provide essential optimization significance for multi-DOF systems.

Typical multi-DOF motors are generally defined as motors having two or three rotational DOFs that are capable of rotating around any axis in a fixed-point space. These include: spherical motors and deflection motors applied in omnidirectional devices such as robotic joints and electric gyroscopes; dual-mechanical-port motors utilized in hybrid electric vehicles; counter-rotating dual-rotor switched reluctance motors employed in propulsion systems; dual-rotor radial-flux motors used in air conditioners to simultaneously drive condensers and evaporators; dual-three-phase dual-stator axial-flux permanent magnet motors applied in knee and hip joints of quadruped robots; and coaxial multi-axis stepping motors utilized in multi-joint robotic arms. Meanwhile, rotary-linear motors capable of both linear and rotary motions are also included in the category of multi-DOF motors, which are applied in robotic joint drives, micro-medical flaw detection devices, and the like.

However, multiple sets of stator windings and multiple rotor structures are typically equipped in most multi-DOF motors, and thus those machines are essentially regarded as mere combinations of multiple single-axis motors. Multiple sets of drivers and controllers are still required for these motors, complex manufacturing processes are involved, and no significant advantages over conventional multi-motor control systems are offered. Furthermore, complex structural designs, dynamic analysis methods, and control strategies are involved in spherical motors and deflection motors with multi-stator and single-rotor structures, whereby their practical applications are limited.

### SUMMARY OF THE INVENTION

To address the issues in the aforementioned existing multi-DOF motors for the multi-axis system, the present invention proposes a coaxial triple-DOF single motor with its topology and structure design method thereof, which is easy to manufacture and allows for controlling multiple rotors within a single stator.

The coaxial multi-DOF single motor designed by the method of the present invention is a coaxial triple-DOF single motor, namely a multi-axis motor. Multiple rotors are controlled through a single set of stator windings to achieve a multi-DOF control effect within a single motor. The advantages of high multi-axis synchronicity and a compact overall structure are provided.

The technical solution adopted by the present invention is as follows:

(S1) A set of concentrated windings is adopted for the stator part of the motor. The related parameters of the winding are configured based on the number of DOFs through the variable slot pitch angle method.

(S2) Subsequently, the rotors of the motor adopt the hybrid-embedded structure and are arranged in a coaxial-nested configuration to form the coaxial multi-DOF single motor. The parameters of the rotor part are configurated according to the structural parameters of the stator part.

Finally, the coaxial multi-DOF single motor is manufactured according to the topology and structure designed by the method of the present invention.

Multiple teeth are arranged on the inner peripheral surface of the stator part at intervals along the circumferential direction. The tooth number is configured as an n-multiple of the phase number, n being a natural number. The coil is wound on each of the main teeth to serve as a concentrated winding.

The step S1 comprises:

(S11) The phase number of the motor and the number of rotors are designed through the variable slot pitch angle method according to the number of DOFs.

(S12) The split-tooth structure is added to the stator teeth to introduce the flux modulation effect. Then, the pole-pair number of the armature magnetic field is increased. The number of the split-tooth is configured according to the splitting number.

In step S11, the phase number of the motor and the number of shafts are configured according to the number of DOFs of the coaxial multi-DOF single motor.

In the coaxial multi-DOF single motor, a minimum constraint of phase number is first established through the number of DOFs according to the formula as follows:

$$m ⩾ 2 {n}_{DOF}$$

where n_{DOF} represents the number of DOFs of the coaxial multi-DOF single motor, m is the phase number of the motor.

Furthermore, an additional phase is added according to the minimum constraint of the phase number based on Kirchhoff's Law. The most suitable phase number is calculated according to the following formula:

$$m = 2 {n}_{DOF} + 1$$

where m is the phase number of the motor.

Meanwhile, the number of rotors of the coaxial multi-DOF single motor is designed to be consistent with the number of DOFs.

The step S12 specifically comprises:

The split-teeth are arranged in an annular air gap as the flux modulator. The split-teeth are formed by arranging multiple magnetic conducting blocks at intervals on the end surface of each tooth of the stator part. Each of the magnetic conducting blocks serves as one tooth of the split-teeth. A slot of the split-teeth is formed between two adjacent magnetic conducting blocks.

The pole-pair number of the additional air-gap magnetic field introduced after adding the flux modulator is configured according to a formula as follows:

$${p}_{ad} = {p}_{a}$$

where p_{ad} is the pole-pair number of the additional air-gap magnetic field, and pₐ represents the pole-pair number of the armature magnetic field of the m-phase coaxial multi-DOF single motor.

After adopting the split-teeth, the pole-pair number of the excitation magnetic field of the coaxial multi-DOF single motor is obtained according to the following formulas, and the pole-pair number of the flux modulators is equivalently obtained:

$${p}_{ad} = \vert {p}_{e} - {p}_{f} \vert$$

$${p}_{f} = {n}_{f} {Z}_{s}$$

where pₑ is the pole-pair number of the excitation magnetic field, which equals the number of teeth on individual gears within the hybrid-embedded rotor. p_{f} is the pole-pair number of the flux modulator, which is the total number of the magnetic conducting blocks, and is the total number of the split-teeth in the structure adopting the split-teeth. Zₛ is the slot number, which is consistent with the main tooth number of the stator part. n_{f} represents the tooth number on each of the split-teeth.

The step S2 comprises:

(S21) The rotors of the motor adopt the hybrid-embedded structure.

(S22) Multiple hybrid-embedded rotors are arranged along the axial direction with the coaxial axes. The number of rotors is consistent with the number of DOFs of the motor. Polarities of the adjacent rotors are designed to be opposite.

(S23) A nested-shaft structure is adopted to connect different rotors and offers a stable structure for multi-rotor operation. The adjacent shafts are connected through ball bearings to form the integral rotor part.

In step S21, one axially magnetized permanent magnet is embedded and fixed between two gears to form the hybrid-embedded structure. Each of the gears is formed by laminating multiple silicon steel sheets along the axial direction. The number of teeth on the two gears is identical and is equal to pₑ, where pₑ=pₐ+p_{f} is calculated through the pole-pair number of the armature magnetic field (pₐ) and the pole-pair number of the flux modulators (p_{f}). The two gears are staggered by one tooth pitch from each other along the circumferential direction. The permanent magnet is axially magnetized such that the two gears are magnetized as an N-pole and an S-pole, respectively.

In step S22, multiple hybrid-embedded rotors are arranged along the axial direction at equal intervals under the coaxial configuration. The number of rotors is consistent with the number of DOFs of the motor. The axial magnetic polarities of the adjacent rotors are designed to be opposite.

In step S23, each of the hybrid-embedded rotors is fixedly sleeved on the corresponding shaft. Multiple shafts are connected through the ball bearings in sequence from inside to outside. Each of the shafts is connected to and driven by a respective power source to rotate. Consequently, the hybrid-embedded rotors are combined through a coaxial nested-shaft configuration to achieve independent rotations corresponding to different DOFs.

Finally, the specific coaxial multi-DOF single motor of the present invention can be designed and manufactured by adopting the aforementioned topology and structure design method.

The innovation of the present invention resides in the structural design of axially stacking multiple rotors within a single set of windings and the arrangement of multiple coaxial and nested shafts. Through these features, the advantage of further improving the structural compactness of the multi-DOF motor is provided, and the effect of outputting multiple controllable DOFs from a single motor is achieved. Compared with conventional multi-motor systems, the advantages of high integration and high synchronicity are offered by the present invention for the output of multiple controllable DOFs.

The coaxial multi-DOF single motor of the present invention refers to a motor having multiple coaxial, independently rotatable, and controllable rotors. Each of the rotors is connected to and driven by a respective power source to rotate.

The coaxial multi-DOF single motor is a multiphase concentrated winding motor with the phase number greater than or equal to 3, and is also an end-part star-connected motor.

The motor designed in the present invention is based on the variable slot pitch angle principle. Rotating magnetic fields with different pole-pair numbers are respectively generated by a single set of stator windings, whereby decoupled control of the three rotors is achieved, and triple-DOF operation is realized. Meanwhile, based on the flux modulation principle, the rotating magnetic fields generated by the stator windings are modulated by adding the split-tooth structure. Then, additional air-gap magnetic fields with increased pole-pair numbers are obtained. The pole ratio is increased such that the electromagnetic torque is enhanced, enabling open-loop control to be implemented under light-load conditions. Furthermore, the aforementioned principles and the decoupled operation performance are verified through the finite element simulation method. Finally, experiments are conducted on the manufactured prototype to verify the feasibility of the proposed multi-DOF motor in achieving triple-DOF operation.

The beneficial effects of the present invention are as follows:
1) A coaxial multi-DOF single motor is designed by the method of the present invention. Based on the variable slot pitch angle method, the phase number of the motor is configured according to the required number of controllable DOFs. The pole-pair number of the armature magnetic field is increased through the split-tooth structure. Based on the flux modulation principle, the pole ratio is expanded to increase the output torque of the motor, whereby open-loop operation is enabled under light-load conditions.
2) A hybrid-embedded rotor equipping a high pole-pair number is designed by the method of the present invention. Conventional surface-mounted permanent magnets are converted into a simplified structure comprising two gears and a single axially magnetized permanent magnet. The processes of processing and surface-mounting a large number of permanent magnets are eliminated. Especially in small-sized motors with high pole-pair numbers, the difficult and low-precision permanent magnet mounting process is avoided. Consequently, the production cost and manufacturing difficulty of the motor are significantly reduced.
3) The coaxial multi-DOF single motor designed by the method of the present invention offers multiple controllable DOFs from a single motor. Compared with the conventional multi-motor combinations for multi-DOF control, the present invention has the advantages of simplified installation, high multi-axis synchronicity, and a compact overall structure.

In conclusion, a topology and structure design method for a coaxial multi-DOF single motor, which utilizes a single rotating magnetic field to simultaneously control multiple rotors, is proposed in the present invention. The principles and topology types of multi-DOF motors are expanded. Advantages such as a compact structure, easy installation, and open-loop operation under light loads are provided by the proposed motor topology. Conventional multi-motor combinations can be replaced by the proposed motor in application scenarios requiring multiple-axis drive. Thus, great application potential is possessed in the coaxial multi-DOF single motor.

### BRIEF DESCRIPTION OF THE DRAWINGS

FIG. 1 is a flow chart of the design method of the present invention.

FIG. 2 is a schematic diagram of the phase band division using the variable slot pitch angle method for the 7-phase, triple-DOF motor in the embodiment.

FIG. 3 is a schematic diagram of 7-phase concentrated and consequent-pole windings with a drive circuit of the embodiment.

FIG. 4 is a schematic diagram of a hybrid-embedded rotor structure in the triple-DOF motor of the embodiment.

FIG. 5 is a schematic diagram of coaxial nested-shafts of the 7-phase triple-DOF motor of the embodiment.

FIG. 6 is a photograph of the rotor part of the 7-phase triple-DOF motor of the embodiment.

### DETAILED DESCRIPTION OF THE EMBODIMENTS

The present invention will be further described in detail below with reference to the accompanying drawings and specific embodiments.

The coaxial multi-DOF single motor designed by the present invention comprises a stator part and a rotor part.

The stator part is sleeved on the outer periphery of the rotor part. An annular air gap is provided between the stator part and the rotor part.

Multiple teeth are arranged on the inner peripheral surface of the stator part at intervals along the circumferential direction. The tooth number is an n-multiple of the phase number, n being a natural number. Slots are formed between adjacent teeth. A coil is wound on each of the teeth to serve as a concentrated winding. Magnetic conducting blocks can be arranged on the inner end surface of each of the teeth to form split-teeth. All of the teeth have an identical radial length. An air gap exists between the inner surfaces of all the teeth and the outer surface of the rotor part.

In the specific implementation, the number of teeth of the stator part is an n-multiple of the phase number, n being a natural number. Each of the teeth and the coil wound thereon, namely the concentrated winding, serves as one phase. All of the phases are uniformly distributed at intervals along the circumferential direction.

If at least two coil windings exist in the same phase, all the coil windings of the same phase are arranged rotationally and symmetrically along the circumferential direction. All the coil windings of the same phase are connected in series. The coil windings of different phases are connected in parallel. After being led out, the coil windings of each phase are connected to an external pulse controller through a half-bridge drive circuit.

The rotor part comprises multiple coaxially arranged, independently rotatable, and controllable rotors. All the rotors are coaxially and movably sleeved together and rotate independently of each other. Each of the rotors mainly comprises one shaft, two gears, and one permanent magnet fixedly and coaxially sleeved on the shaft. The number of teeth on the two gears is identical. The permanent magnet is embedded between two gears, such that the permanent magnet is located between the two gears. Each of the rotors is connected to and driven by a respective power source to rotate.

The teeth of two gears within each of the rotor is identical, while those of the gears from different rotors are different. The number of rotors is consistent with the number of DOFs of the motor.

In the specific implementation, the integral hybrid-embedded rotor, composed of the two gears and the permanent magnet in each of the rotors, is fixedly sleeved at the bottom of the shaft. The shafts of the respective rotors are sleeved in sequence from inside to outside through ball bearings, such that the integral hybrid-embedded rotor composed of the two gears and the permanent magnet is coaxially arranged at intervals along the axial direction.

Different rotors are movably sleeved and connected coaxially from inside to outside through a nested-shaft structure. The adjacent shafts are connected through ball bearings, such that the plurality of rotors of the motor can operate independently of each other.

Within each of the rotors, each of the gears is formed by laminating multiple silicon steel sheets along the axial direction. The two gears within each of the rotors are staggered from each other by one tooth pitch along the circumferential direction, such that the teeth of the upper gear are axially aligned with the slots of the lower gear.

The permanent magnet is axially magnetized, such that the two gears are magnetized as an N-pole and an S-pole, respectively.

The specific embodiment and the design process of the present invention are as follows:

Taking the design of a coaxial triple-DOF single motor by the method of the present invention as an example, the topology and structure design method of the multi-DOF single motor of the present invention is as follows:

A set of concentrated windings is adopted for the stator part of the motor. Multiple teeth are arranged on the inner peripheral surface of the stator part at intervals along the circumferential direction. The tooth number is an n-multiple of the phase number, n being a natural number. The coil is wound on each of the main teeth to serve as a concentrated winding.

As shown in FIG. 2, a schematic diagram of phase-band division using the variable slot pitch angle method for a 7-phase triple-DOF motor is provided. When the slot pitch angles are π/2, π/4, and π/6, respectively, the phase-bands are sequentially divided into 4, 8, and 12, and the armature magnetic field presents 2, 4, and 6 pole pairs.

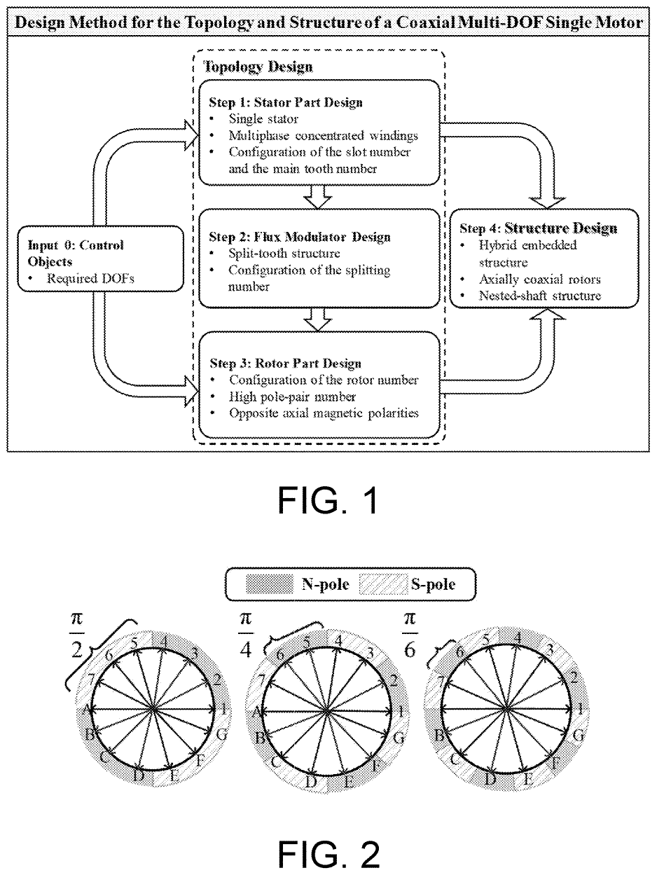

The flow chart of the design method of the present invention is shown in FIG. 1.

1) The phase number of the motor and the number of the rotors are configured through the variable slot pitch angle method proposed in the present invention according to the required DOFs of the motor.

The phase number of the motor and the number of rotors are both configured according to the number of DOFs of the coaxial multi-DOF single motor.

Under normal circumstances, the excitation sequence of the current in each phase is determined, i.e., following A-B-C . . . . The pole-pair number of the armature magnetic field formed by energizing all the stator coils depends on the arrangement of the coil windings. For a fixed set of motor windings, the pole-pair number of the armature magnetic field remains constant. However, in the coaxial multi-DOF single motor of the present invention, control redundancy exists in the multiphase windings. The pole-pair number of the armature magnetic field is changed by varying the phase difference of the excitation in each phase.

For an m-phase coaxial multi-DOF single motor with the slot number Zₛ and the pole-pair number p, the slot pitch angle is calculated by α=(2pπ)/Zₛ. The slot pitch angle is used to characterize the phase difference of the current vectors in adjacent slots.

When the slot number Zₛ is determined, the pole-pair number p of the coaxial multi-DOF single motor is related to the slot pitch angle α and varies with the change of the slot pitch angle α.

Based on the definition of the slot pitch angle, the following method is adopted to change the pole-pair number of the armature magnetic field: the original winding arrangement is maintained, and the excitation sequence is changed to change the slot pitch angle. This approach is defined as the variable slot pitch angle method.

For the coaxial multi-DOF single motor of the present invention, which requires the simultaneous existence of multiple armature magnetic field pole-pair numbers, only one fixed form of winding arrangement exists. The aforementioned method is required to achieve the variation of the pole-pair number of the armature magnetic field, such that different rotating magnetic fields are generated to control different rotors.

A concentrated winding motor under the condition where the slot number/main tooth number is consistent with the phase number is defined as the minimum unit repeating motor. Specifically, the minimum unit repeating motor of an m-phase motor is an m-slot concentrated winding motor.

In an m-phase motor with the slot number/tooth number being km, the pole-pair number of the armature magnetic field is k times the pole-pair number of the minimum unit repeating motor. By analyzing the pole-pair number of the armature magnetic field of the minimum unit repeating motor, all possible cases of the pole-pair numbers of the armature magnetic field based on the variable slot pitch angle method can be explored.

A constraint is established that the pole-pair number of the armature magnetic field of the minimum unit repeating motor is not greater than the phase number, satisfying 2p≤m. Therefore, the m-phase minimum unit repeating motor can generate at most └m/2┘ pole-pair numbers through the variable slot pitch angle method, where └ ┘ represents the floor function.

Thus, in a conventional three-phase minimum unit repeating motor, at most one pole can be generated. The pole-pair number of the armature magnetic field can only be increased by enlarging the slot numbers and changing the winding arrangement. In contrast, in the multiphase (m>3) motor of the present invention, the excitation sequence of the currents of each phase can be changed due to the increased phase number. This control redundancy allows the minimum unit repeating motor to generate an increased pole-pair number of the armature magnetic field.

Based on this, in the coaxial multi-DOF single motor, a minimum constraint of phase number is first established through the number of DOFs n_{DOF} according to the following formula:

$$m ⩾ 2 {n}_{DOF}$$

where n_{DOF} represents the number of DOFs of the coaxial multi-DOF single motor.

Furthermore, the star connection is adopted for the windings of the coaxial multi-DOF single motor. Thus, an additional phase is added according to the minimum constraint of phase number based on Kirchhoff's Law of circuits. Then, the most suitable number of stator phases is calculated according to the required number of DOFs based on the following formula:

$$m = 2 {n}_{DOF} + 1$$

The number of rotors of the coaxial multi-DOF single motor is designed to be consistent with the number of DOFs.

In this embodiment, the phase number required for the triple-DOF motor is deduced as follows:

$$m = 2 \times 3 + 1 = 7$$

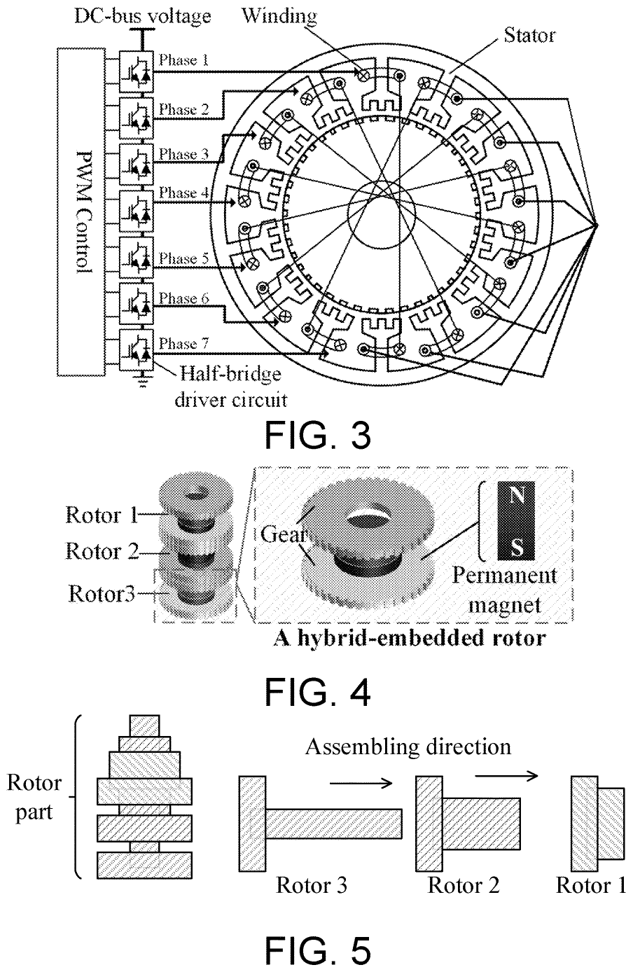

As shown in FIG. 3, a schematic diagram of 7-phase concentrated and consequent-pole windings with a drive circuit is provided. The phases are arranged in a counter-clockwise direction in the sequence of phases 1-2-3-4-5-6-7. A star connection is adopted at the end-part. Three types of armature magnetic fields can be generated by the 7-phase concentrated winding, with pole-pair numbers of 2, 4, and 6, respectively. For the three control DOFs, the number of rotors is designed to be three.

2) Based on the flux modulation principle, the split-tooth structure is added to the main teeth of the stator, and thus the pole-pair number of the armature magnetic field is increased. This feature enlarges the pole ratio and increases the electromagnetic torque, enabling open-loop operation under light-load conditions.

Specifically, the split-teeth are arranged in the annular air gap as the flux modulator. The split-teeth are formed by arranging multiple magnetic conducting blocks at intervals on the inner end surface of each tooth of the stator part. Each of the magnetic conducting blocks serves as one tooth of the split-teeth. One slot of the split-teeth is formed between two adjacent magnetic conducting blocks.

According to the flux modulation principle, after the flux modulators are added in the annular air gap, the magnetic permeability of the flux modulator is greater than that of air. The magnetic flux tends to pass through the flux modulator, thereby introducing new magnetic field harmonics and changing the air-gap magnetic field.

The pole-pair number of the additional air-gap magnetic field introduced by adding the flux modulator is:

$${p}_{ad} = {p}_{a}$$

where p_{ad} is the pole-pair number of the additional air-gap magnetic field, and pₐ represents the pole-pair number of the armature magnetic field of the m-phase motor.

After adopting the split-teeth, the pole-pair number of the excitation magnetic field pₑ of the coaxial multi-DOF single motor is obtained according to the following formulas:

$${p}_{ad} = \vert {p}_{e} - {p}_{f} \vert$$

$${p}_{f} = {n}_{f} {Z}_{s}$$

where pₑ is the pole-pair number of the excitation magnetic field, which is the tooth number on individual gears for the hybrid-embedded rotor, and is also the pole-pair number of the permanent magnets. In the hybrid-embedded rotor, pₑ is equal to the tooth number p_{g} of each gear in the rotor. p_{f} is defined as the number of magnetic conducting blocks of the flux modulator, which equals 3×14=42 in this specific implementation. Zₛ is the slot number, which is consistent with the main tooth number of the stator part. n_{f} represents the tooth number on each of the split-teeth, which is a preset parameter.

Because the pole-pair number of the armature magnetic field of the motor is expanded by introducing the split-tooth structure as the flux modulator, the proposed multi-DOF motor equips a high pole-pair number, thereby having a high pole ratio and high output torque. Thus, it is similar to a stepping motor and can achieve open-loop operation under light-load conditions.

As shown in FIG. 3, the stator of the designed 7-phase triple-DOF motor adopts a 14-slot structure, where Zₛ=14. Each stator tooth has 3 split-teeth as an auxiliary of the main tooth. Therefore, there exists a total of 14 main teeth and 42 small teeth. The adopted split-teeth can be calculated as: p_{f}=n_{f}Zₛ=3×14=42.

As mentioned above, the 7-phase 14-slot concentrated and consequent-pole windings can generate armature magnetic fields with pole-pair numbers of 2, 4, and 6. Therefore, the corresponding pole-pair numbers of the excitation magnetic field pₑᵣ should be:

$${p}_{e 1} = 42 + 2 = 44$$

$${p}_{e 2} = 42 + 4 = 46$$

$${p}_{e 3} = 42 + 6 = 48$$

3) The rotors adopt the hybrid-embedded structure, such that the permanent magnet rotor under the aforementioned high pole-pair number of the excitation magnetic field can be realized under low manufacturing complexity.

To match the pole-pair number of the excitation magnetic field (pₑ) with the high pole-pair number armature magnetic field obtained through flux modulation effect in step 2), the conventional surface-mounted permanent magnet rotor is modified in the present invention. The hybrid-embedded structure is adopted to achieve the required permanent magnet rotor with a high pole-pair number.

In this step, one axially magnetized permanent magnet is embedded and fixed between two gears, forming a hybrid-embedded structure. Each of the gears is formed by laminating multiple silicon steel sheets along the axial direction. The tooth number on each gear is identical and is equal to pₑ, which is calculated through the pole-pair number of the armature magnetic field and the pole-pair number of the flux modulators by pₑ=pₐ+p_{f}. The two gears are staggered from each other by one tooth pitch along the circumferential direction. The permanent magnet is axially magnetized, such that the two gears are magnetized as an N-pole and an S-pole, respectively.

When axial magnetic flux is ignored, the hybrid-embedded rotor with a gear tooth number p_{g} is equivalent to a surface-mounted permanent magnet rotor with a pole-pair number pₑ, namely pₑ=p_{g}.

By converting surface-mounted permanent magnets into gears, the processes of processing and surface-mounting permanent magnets are eliminated by the aforementioned hybrid-embedded structure of the present invention. Especially in small-sized motors with high pole-pair numbers, the difficult and low-precision permanent magnet mounting process is avoided. Consequently, the production cost and manufacturing difficulty of the motor are significantly reduced.

As shown in FIG. 4, the number of teeth on the gear (p_{gr}) of the three rotors (r∈[1,3]) is 44, 46, and 48, respectively, which can be equivalent to the pole-pair number of the rotors, namely pₑᵣ=p_{gr}.

4) Multiple hybrid-embedded rotors are arranged along the axial direction with the coaxial axes. The number of rotors is consistent with the number of DOFs of the motor. The axial magnetic polarities of the adjacent hybrid-embedded rotors are arranged to be opposite to each other, whereby the coupling of the axial magnetic fields between different rotors is weakened.

In this step, multiple hybrid-embedded rotors are arranged at equal intervals along the axial direction under the coaxial configuration. The axial magnetic polarities of each adjacent hybrid-embedded rotor are arranged to be opposite to each other.

In the specific implementation of a 7-phase triple-DOF motor, as shown in FIG. 3, three hybrid-embedded rotors are arranged coaxially along the axial direction. The three hybrid-embedded rotors are arranged at equal intervals along the axial direction of the motor. The axes of the rotors are collinear. Each of the adjacent hybrid-embedded rotors is arranged in a manner of having opposite axial magnetic polarities. Specifically, in the axial direction from the output shaft side to the bottom of the motor, the magnetic polarities are in a sequence of “Rotor 1 (N-S)→Rotor 2 (S-N)→Rotor 3 (N-S) . . . ”, to minimize the spatial coupling of the magnetic fields of different rotors.

5) A nested-shaft structure is adopted to connect different rotors and offer a stable structure for multi-axis operation. The adjacent shafts are connected through the ball bearings to form the integral rotor part, such that the plurality of rotors of the motor can operate and output independently.

In step 5), each of the hybrid-embedded rotors is fixedly sleeved on the bottom of a corresponding shaft. The diameters of the shafts corresponding to different rotors are different. The shafts corresponding to the rotors are movably sleeved and connected through the ball bearings in sequence from inside to outside. Each of the shafts is connected to and driven by a respective power source to rotate. Thus, multiple shafts are combined through a coaxial-nested structure to achieve independent rotations of rotors corresponding to different DOFs.

As shown in FIG. 5, the three shafts of the triple-DOF motor are combined in a nested manner. Specifically, shaft 3 is inserted into shaft 2, and then both are inserted into shaft 1 together to complete the nested-shaft assembly. The shafts are in contact through ball bearings and are independent of each other under ideal conditions.

Specifically, the design principle of the nested-shafts is as follows: the shaft farthest from the output side and closest to the bottom of the motor has the smallest diameter and the longest length. The diameters of the shafts closer to the outer side are gradually increased while the lengths are reduced. Thus, the shafts of the rotors from the outer side to the inner side of the motor can be inserted into the preceding rotors along the axial direction. Consequently, the nested-shaft structure is achieved.

Finally, the coaxial multi-DOF single motor is manufactured according to the topology and structure designed by the method of the present invention.

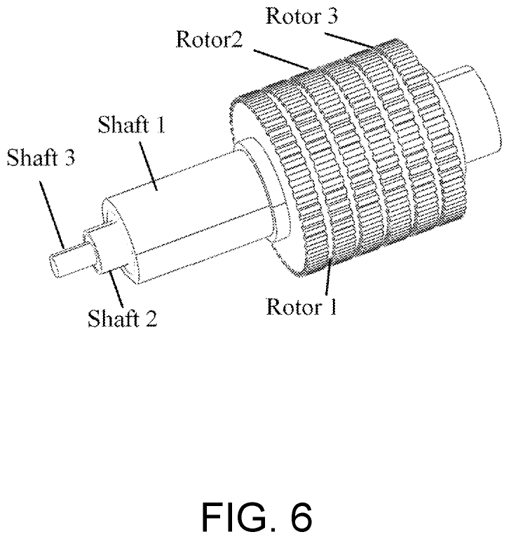

In the embodiment of the present invention, the designed coaxial 7-phase triple-DOF motor is used to perform multi-DOF control test experiments. The photograph of the rotor part of the prototype is shown in FIG. 6. Control signals generated by RT-LAB equipment are used to drive the 7-phase half-bridge circuit. The control frequency is 20 kHz, and the bus voltage is 5 V. The PWM generation method is the SPWM. Open-loop control is adopted throughout the experiment, and the load condition is no-load. To verify the decoupled operation characteristics of the triple-DOF motor, the operation performances of Rotor 1, Rotor 2, and Rotor 3 are respectively tested under different operation conditions, including the same direction, opposite direction, the same speed, and different speeds, as shown in Table 1.

TABLE 1
Experiment results of the decoupled
operation in the triple-DOF motor

| Experiment conditions | | | | |
|---|---|---|---|---|
| | Rotor 1 | Rotor 2 | Rotor 3 | Feasibility of |
| | speed | speed | speed | decoupled |
| Direction | (r/min) | (r/min) | (r/min) | operation |
| Same | 30 | 30 | 30 | Yes |
| direction | 10 | 20 | 30 | Yes |
| | 50 | 20 | 10 | Yes |
| Opposite | −30 | −20 | 30 | Yes |
| direction | −30 | 20 | 10 | Yes |
| | 20 | 10 | −30 | Yes |
| | −30 | 20 | −10 | Yes |
| | 20 | −30 | 10 | Yes |

The experimental results indicate that decoupled operation can be realized in the proposed triple-DOF motor under different conditions.

It is demonstrated by the embodiments that multi-DOF decoupled operation can be achieved in the coaxial multi-DOF motor designed by the method of the present invention. Independent control of each rotor is maintained, whereby multi-DOF operation is completed. Furthermore, open-loop operation is realized under no-load conditions, demonstrating strong multi-axis decoupling performance and stability. Compared with conventional multi-motor combinations for multi-axis systems, the advantages of simplified installation, high multi-axis synchronicity, and a compact overall structure are provided by the present invention.

The above description of the embodiments is provided to enable those of ordinary skill in the art to understand and apply the present invention. It is apparent that various modifications to the aforementioned embodiments can be easily made, and the general principles described herein can be applied to other embodiments by those skilled in the art without creative labor. Therefore, the present invention is not to be limited to the embodiments described above. Improvements and modifications made to the present invention by those skilled in the art based on the disclosure of the present invention shall all be deemed to fall within the protection scope of the present invention.

What is claimed is:

1. A design method for a topology and structure of a coaxial multi-DOF single motor, wherein the method comprises:
step S1, a set of concentrated windings is adopted for a stator part of the motor, whose related parameters are configured based on a number of DOFs by using a variable slot pitch angle method;
step S2, subsequently, a rotor part adopts the hybrid-embedded structure and coaxial-nested shafts, such that the multi-rotor operation within a single motor is realized; parameters of the rotor part are configured according to parameters of the stator part and the configuration of the windings.

2. The design method for the topology and structure of a coaxial multi-DOF single motor according to claim 1, wherein: multiple stator teeth are arranged on an inner peripheral surface of the stator part at intervals along a circumferential direction; a tooth number is set to be an n-multiple of a phase number, n being a natural number; a coil is wound on each of main teeth to serve as a concentrated winding.

3. The design method for the topology and structure of a coaxial multi-DOF single motor according to claim 1, wherein the step S1 comprises:
step S11, a phase number of the motor and a number of rotors are configured by a variable slot pitch angle method according to the number of DOFs of the coaxial multi-DOF single motor;
step S12, the split-tooth structure is added on the stator teeth based on a flux modulation principle, increasing a pole-pair number of an armature magnetic field; a splitting number of the split-tooth is designed according to a pole ratio.

4. The design method for the topology and structure of a coaxial multi-DOF single motor according to claim 3, wherein:
in the step S11, the phase number of the motor and the number of rotors are configured according to the number of DOFs of the coaxial multi-DOF single motor;
in the coaxial multi-DOF single motor, a minimum constraint of phase number is first established through the number of DOFs according to the formula as follows:
$$m ⩾ 2 {n}_{DOF}$$
where n_{DOF} represents the number of DOFs of the coaxial multi-DOF single motor, m is the phase number;
moreover, an additional phase is introduced for a constraint of the phase number based on Kirchhoff's Law; the most suitable phase number is calculated according to a formula as follows:
$$m = 2 {n}_{DOF} + 1 ,$$
meanwhile, the number of rotors of the coaxial multi-DOF single motor is designed to be the same as the number of DOFs.

5. The design method for the topology and structure of a coaxial multi-DOF single motor according to claim 3, wherein the step S12 comprises:
a split-teeth are arranged in a circular air gap as a flux modulator, which is formed by arranging several magnetic conducting blocks at intervals at an end surface of each main tooth of the stator part; each of the magnetic conducting blocks serves as one tooth of the split-teeth; slots of the split-tooth structure are formed between adjacent magnetic conducting blocks;
an additional air-gap magnetic field is introduced by adding the flux modulator, whose pole-pair number p_{ad} can be calculated according to the following formula:
$${p}_{ad} = {p}_{a}$$
where pₐ represents the pole-pair number of the armature magnetic field of the motor;
after adopting the split-teeth, the pole-pair number of an excitation magnetic field of the coaxial multi-DOF single motor is obtained according to the following formulas, and the pole-pair number of the flux modulator is obtained:
$${p}_{ad} = \vert {p}_{e} - {p}_{f} \vert$$
$${p}_{f} = {n}_{f} {Z}_{s}$$
where pₑ is the pole-pair number of the excitation magnetic field, which equals the tooth number of individual hybrid-embedded rotors; p_{f} is the pole-pair number of the flux modulator, which is a total number of the magnetic conducting blocks, and is consistent with the total number of the split-teeth in the structure adopting the split-teeth; Zₛ is a slot number of the motor, which also represents the number of main teeth in the stator; ne is the splitting number of the split-tooth, representing a split-tooth number on each main tooth.

6. The design method for the topology and structure of a coaxial multi-DOF single motor according to claim 1, wherein the step S2 comprises:
step S21, the rotors of the motor adopt the hybrid-embedded structure;
step S22, hybrid-embedded rotors are arranged along an axial direction through a coaxial configuration; the number of rotors is consistent with the number of DOFs of the motor; meanwhile, the axial polarities of the adjacent hybrid-embedded rotors are designed to be opposite to each other;
step S23, a nested-shaft structure is adopted to connect different rotors and offers a stable structure for multi-rotor operation; the adjacent shafts are connected through ball bearings to form the integral rotor part.

7. The design method for the topology and structure of a coaxial multi-DOF single motor according to claim 6, wherein the step S21 comprises:
one axially magnetized permanent magnet is embedded and fixed between two gears to form the hybrid-embedded rotor; each of the gears is formed by laminating multiple silicon steel sheets along the axial direction; the tooth number of two gears is identical and is equal to pₑ, which is calculated through pₑ pₐ+p_{f} by the pole-pair number of the armature magnetic field pₐ and the pole-pair number of the flux modulators p_{f} based on the flux modulation principle; the two gears are staggered by one tooth pitch from each other along a circumferential direction.

8. The design method for the topology and structure of a coaxial multi-DOF single motor according to claim 6, wherein in the step S22:
the hybrid-embedded rotors are arranged along the axial direction at equal intervals under the coaxial configuration; the number of rotors is consistent with the number of DOFs of the motor;
axial magnetic polarities of the adjacent hybrid-embedded rotors are designed to be opposite to each other.

9. The design method for the topology and structure of a coaxial multi-DOF single motor according to claim 6, wherein in the step S23:
each of the hybrid-embedded rotors is fixed on the corresponding shaft to construct a rotor-shaft part; the shafts are movably nested through the ball bearings in sequence from inside to outside; each of the shafts is connected to and driven by a respective power source to rotate; consequently, the hybrid-embedded rotors are combined in a nested-shaft structure to achieve independent rotations corresponding to different DOFs.

10. A coaxial multi-DOF single motor, wherein the motor is designed and obtained by the topology and structure design method according to claim 1.
